(19) United States
(12) Patent Application Publication
(10) Pub. No.: US 2011/0007354 A1
(43) Pub. Date: Jan. 13, 2011

(54) PRINTER AND MESSAGE MANAGING METHOD

(75) Inventors: Kazuaki Seki, Shizuoka (JP); Masayuki Osawa, Shizuoka (JP); Hiroshi Shimomura, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/832,265

(22) Filed: Jul. 8, 2010

(30) Foreign Application Priority Data
Jul. 8, 2009 (JP) 2009-161917
Jun. 4, 2010 (JP) 2010-129000

(51) Int. Cl. G06F 15/00

(52) U.S. Cl. 358/1.15

(57) ABSTRACT

According to one embodiment, a printer includes a commodity file configured to store, by commodity, commodity data including at least names of commodities, a message file configured to store massage data allocated to the commodity data and combined with the commodity data, an extracting unit configured to extract, from the message file, the message data allocated to none of the commodity data, a display unit configured to display the message data extracted by the extracting unit, and a deleting unit configured to delete, from the message file, the message data displayed by the display unit.

### CROSS-REFERENCE TO RELATED APPLICATIONS

This application is based upon and claims the benefit of priority from Japanese Patent Applications No. 2009-161917, filed Jul. 8, 2009; and No. 2010-129000, filed Jun. 4, 2010; the entire contents of both of which are incorporated herein by reference.

### FIELD

Embodiments described herein relate generally to a printer configured to print message data on a label and a method of managing the message data printed on the label.

### BACKGROUND

For example, in a supermarket or the like, a label printer is used. The label printer prints, on print surfaces of labels, names, prices, raw material names, additive names, places of origin, storage methods, storage temperatures, and the like of commodities. The labels printed by the label printer are attached to the respective commodities.

In general, the names of the commodities are different for each of commodity types, sales of which are managed in a store. In general commodities, the prices are the same if the commodities are the same type. However, in the case of commodities such as foods to which labels are attached, respectively, even if the commodities are the same type, in some cases, the prices are different according to differences among weights of contents of the respective foods.

The raw material names, the additive names, and the places of origin depend on contents of the foods and are different according to differences among the contents. In the case of foods with the same contents, even if types of the commodities are different, the raw material names, the additive names, and the places of origin are the same. In general, plural different various raw materials and additives are used in foods. The raw materials and the additives of the foods respectively belong to groups. Many raw material names and additive names are printed side by side on labels of the foods. The storage methods and the storage temperatures also depend on contents of the foods and are different according to differences in packing thereof.

As the commodity names printed on the labels, commodity names in commodity data of a PLU (Price Look Up) file used in a POS (Point Of Sales) system are often diverted. On the other hand, message data such as the raw material names, the additive names, the places of origin, the storage methods, and the storage temperatures have to be individually set as print data of the label printer.

### BRIEF DESCRIPTION OF THE DRAWINGS

FIG. 1 is an external view of a label printer according to an embodiment;

FIG. 2 is a diagram of a print control circuit incorporated in the printer;

FIG. 3 is a schematic diagram of an example of an item number file stored in the printer;

FIG. 4 is a schematic diagram of additional message data stored in the printer;

FIG. 5 is a schematic diagram of an example of an additive file stored in the printer;

FIG. 6 is a schematic diagram of an example of an assistance message file stored in the printer;

FIG. 7 is a functional block diagram of a CPU in the printer;

FIG. 8 is a flowchart for explaining message management for the additive file in the printer;

FIG. 9 is a diagram of contents of unused additive data displayed on a display of the printer;

FIG. 10 is a flowchart for explaining message management for the assistance message file in the printer;

FIG. 11 is a diagram of an unused assistance message file displayed on the display of the printer; and

FIG. 12 is a diagram of the assistance message file displayed on the display of the printer.

### DETAILED DESCRIPTION

In general, according to one embodiment, a printer includes: a commodity file configured to store, by commodity, commodity data including at least names of commodities; a message file configured to store massage data allocated to the commodity data and combined with the commodity data; a printing unit configured to print, in addition to the commodity data, the message data allocated to the commodity data on a label; an extracting unit configured to extract, from the message file, the message data allocated to none of the commodity data; a display unit configured to display the message data extracted by the extracting unit; and a deleting unit configured to delete, from the message file, the message data displayed by the display unit.

An embodiment is explained below with reference to the accompanying drawings.

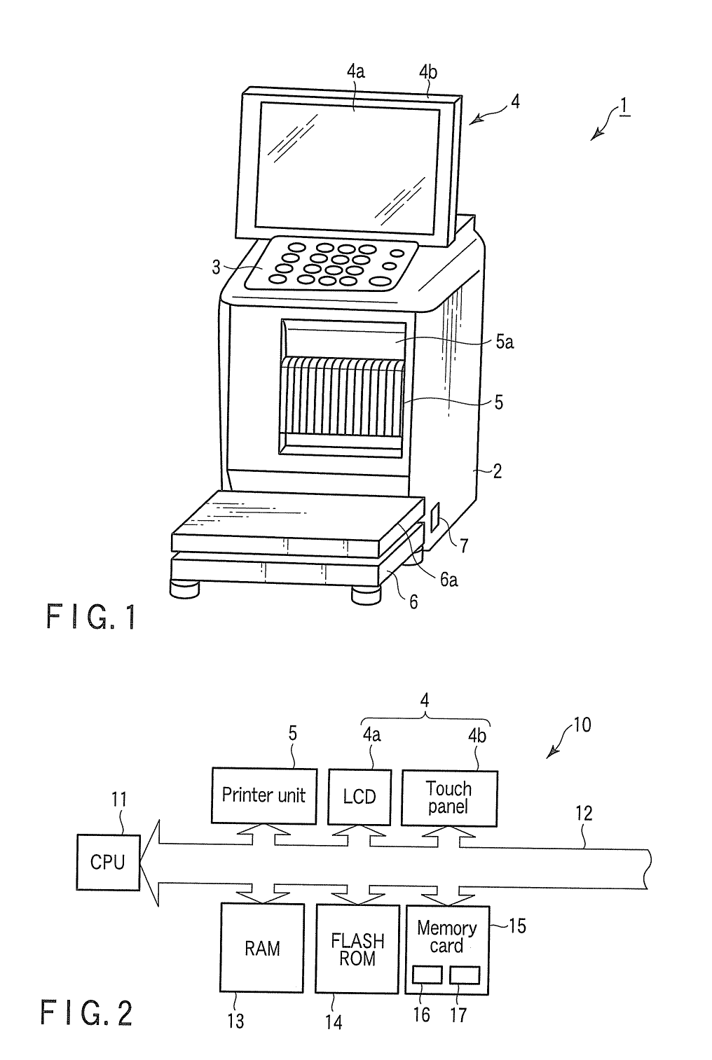

FIG. 1 is an external view of a label printer 1. The label printer 1 prints commodity names, prices, and the like on a label.

The label printer 1 stores, as separate files, commodity data including commodity names and unit prices and message data concerning commodities such as additives to commodities, places of origin, or storage methods. The label printer 1 stores, as separate files by item, the files configured to store the message data.

When the label printer 1 prints the commodity data and the message data on a label, the label printer 1 allocates the message data to the commodity data to be printed on the label and prints the commodity data and the message data on the label. In some cases, one message data is allocated to plural commodities in common. For example, a commodity of one rice ball and a commodity of two rice balls are different commodities. For example, message data of the same additive is allocated to the respective commodities.

The label printer 1 includes a printer body 2. The label printer 1 includes, in the printer body 2, an operation unit 3, a display unit 4, a printer unit 5, a weight measuring device 6, and a power switch 7.

The operation unit 3 includes various operation keys for operating the label printer 1. The display unit 4 includes a liquid crystal display (LCD) 4a of a touch panel type and a touch panel 4b provided on a display screen of the liquid crystal display (LCD) 4a. The display unit 4 displays, on the liquid crystal display 4a, various kinds of information corresponding to processing contents of the label printer 1, for example, data printed on a label. When the display unit 4 receives touch operation by an operator, the display unit 4 outputs, from the touch panel 4b, a signal corresponding to a touch position.

The printer unit 5 includes a printer mechanism. The printer unit 5 includes a discharge port 5a. The printer unit 5 performs printing on a label sheet with the printer mechanism and discharges a label as a printing result from the discharge port 5a. The printer unit 5 is housed in the printer body 2 to be slid in and out of the printer body 2. The printer unit 5 travels on a rail provided in the printer body 2 and is allowed to be slid in and out in the front direction of the label printer 1.

The weight measuring device 6 includes a scale table 6a and measures the weight of commodities and the like placed on the upper surface of the scale table 6a. The power switch 7 turns on and off supply of electric power, which is supplied from the commercial AC power supply, to the label printer 1.

FIG. 2 is a diagram of a print control circuit 10. The print control circuit 10 is incorporated in the printer body 2. The print control circuit 10 controls the operation of label printing by the label printer 1. The print control circuit 10 incorporates a CPU 11. The touch panel 4b and the liquid crystal display 4a of the display unit 4, the printer unit 5, a RAM 13, a flash memory (FLASH ROM) 14, and a memory card 15 are connected to the CPU 11 via a bus 12. The memory card 15 can be attached to and detached from the bus 12.

An item number file 16 and a message file 17 are stored in the memory card 15. The item number file 16 and the message file 17 are not always stored in the memory card 15 and only have to be stored in a nonvolatile memory.

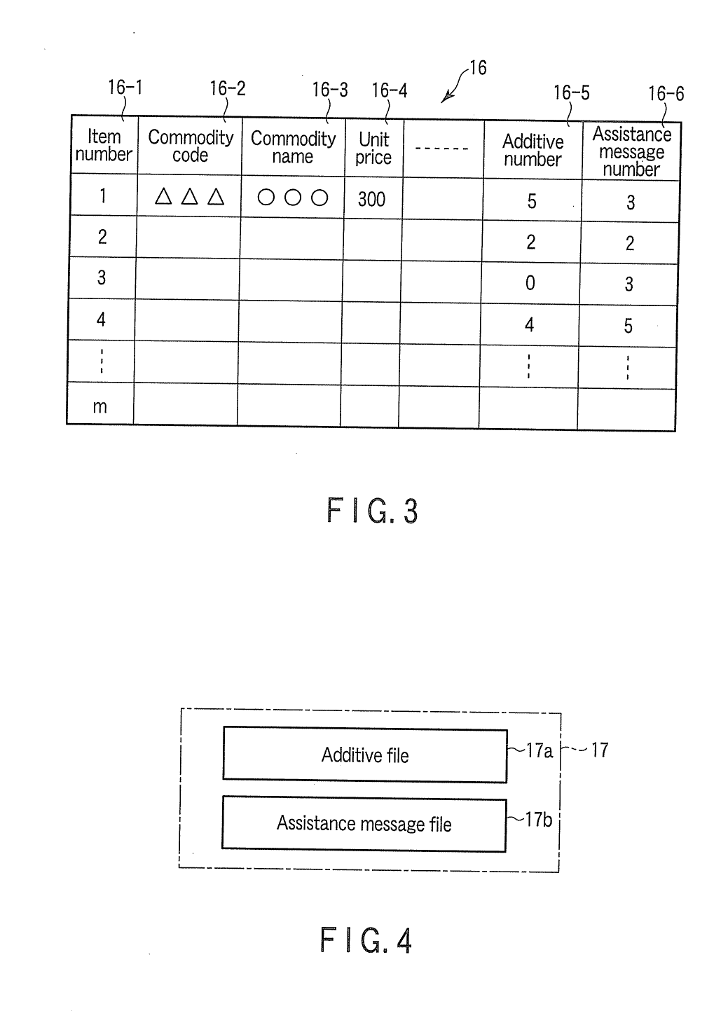

The item number file 16 includes, for example, as shown in FIG. 3, an item number, a commodity code, a commodity name, and a unit price.

The message file 17 as an additional message file in this embodiment includes, for example, an additive file 17a and an assistance message file 17b shown in FIG. 4.

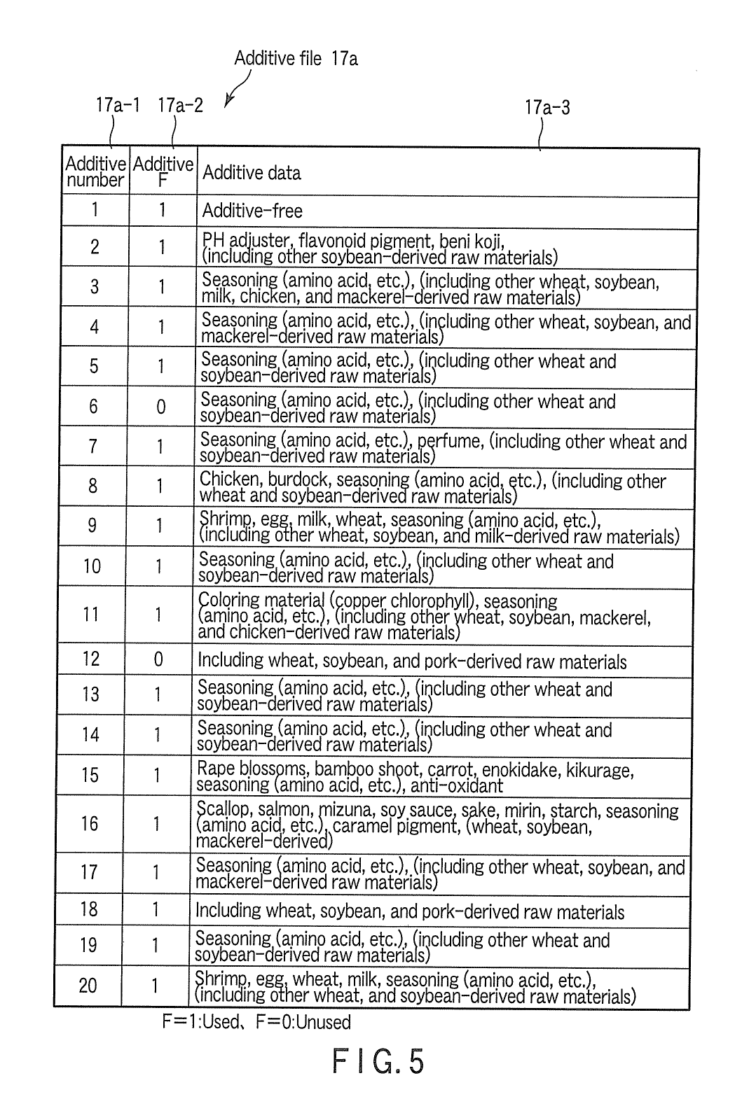

The additive file 17a includes information indicating that no additive is contained in a commodity as indicated by an additive number 1 shown in FIG. 5.

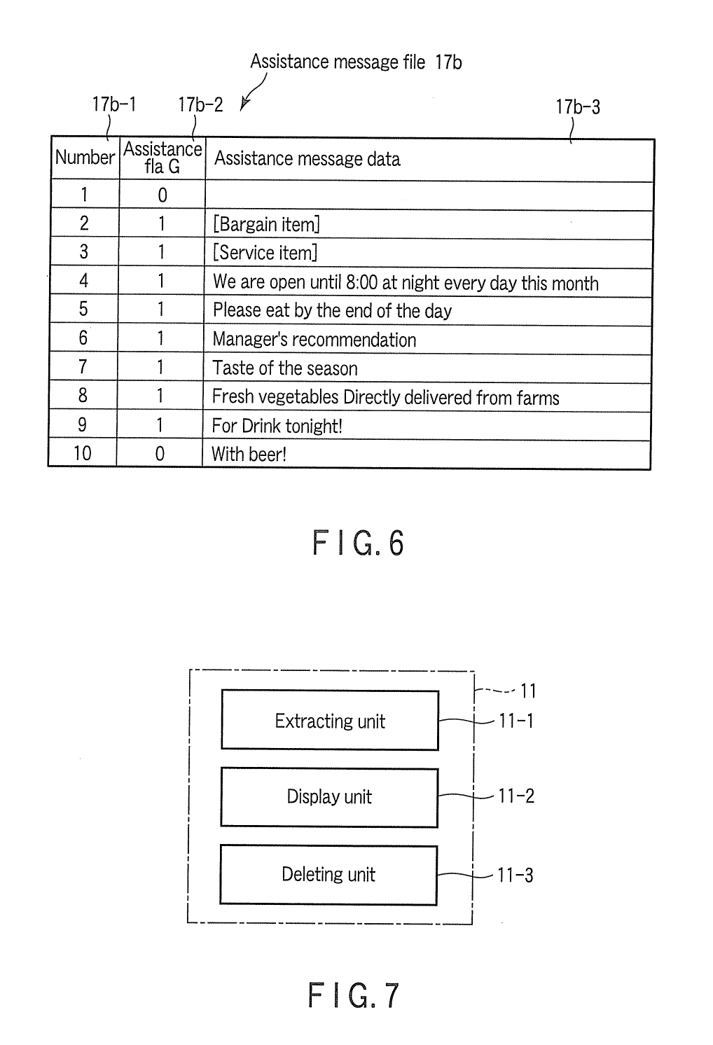

The assistance message file 17b includes, as shown in FIG. 6, assistance messages for promoting sales. The assistance message file 17b includes additional message data such as “bargain item”, “service item”, and “we are open until 8:00 at night everyday this month”.

A specific example of the item number file 16 is explained with reference to the schematic diagram shown in FIG. 3. The item number file 16 has plural item number records associated with commodities. The item number records include several data respectively set and stored in an item number (No) space 16-1, a commodity code space 16-2, a commodity name space 16-3, a unit price space 16-4, an additive number space 16-5, and an assistance message number space 16-6. In the item number (No) space 16-1, item numbers of the commodities such as No. 1, No. 2, . . . , and No. m are set and stored. The item numbers are first identification numbers for identifying commodity records. In the commodity code space 16-2, commodity codes of the commodities are set and stored. In the unit price space 16-4, unit prices of the commodities are set and stored.

In the additive number space 16-5, numbers of additive data attached to the commodities are set and stored. The numbers of the additive data are numbers set and stored in an additive number space 17a-1 in the additive file 17a shown in FIG. 5. The additive number space 16-5 is linked to the additive number space 17a-1 in the additive file 17a. The CPU 11 reads a number set and stored in the additive number space 16-5 to thereby be able to read the additive data 17a-3 of an additive number corresponding thereto from the additive file 17a.

In the assistance message number space 16-6, numbers of assistance messages added to commodity data are set and stored. The numbers of the assistance messages are numbers set and stored in an assistance message number space 17b-1 in the assistance message file 17b shown in FIG. 6. The assistance message number space 16-6 is linked to the assistance message number space 17b-1 of the assistance message file 17b. The CPU 11 reads a number set and stored in the assistance message number space 16-6 to thereby be able to read an assistance message 17b-3 of an assistance message number corresponding thereto from the assistance message file 17b.

A specific example of the additive file 17a is explained with reference to the schematic diagram shown in FIG. 5. The additive file 17a has additive records for respective plural additive item numbers (No). The additive file 17a includes the additive number space 17a-1, a space 17a-2 indicating whether additive data is allocated to commodities, and a space 17a-3 in which data indicating contents of additives added to commodities are set and stored. In the additive number space 17a-1, additive numbers as second identification numbers for identifying additive records such as No. 1, No. 2, . . . , and No. 20 are set and stored in order. In the additive use space 17a-2, discrimination information indicating whether additive data corresponding to the additive numbers No. 1, No. 2, . . . , and No. 20 are allocated to commodities is set and stored. The discrimination information is described by, for example, an additive flag F. The additive flag F is set to, for example, “0” or “1”. If the additive flag F is “0”, this indicates that additive data is not allocated to commodities. If the additive flag F is “1”, this indicates that additive data is allocated to commodities. In the additive data space 17a-3, data of additives is set and stored. An additive number No. 1 indicates additive-free, which means that no additive is added to a commodity. In the additive file 17a shown in FIG. 5, for example, in an additive number No. 2, additive data is a PH adjuster, flavonoid pigment, and the like.

A specific example of the assistance message file 17b is explained with reference to the schematic diagram shown in FIG. 6. The assistance message file 17b has assistance message records for respective plural assistance message numbers (No). The assistance message file 17b includes the assistance message number space 17b-1, a space 17b-2 indicating whether an assistance message 17b-3 is allocated to commodities, and a space 17b-3 in which contents of assistance message data added to commodity data are set and stored. In the assistance message number space 17b-1, assistance message numbers as second identification numbers for identifying assistance message records such as No. 1, No. 2, . . . , and No. 20 are set and stored in order. In the assistance message allocation space 17b-2, discrimination information indicating whether assistance message data corresponding to the assistance message numbers No. 1, No. 2, . . . , No. 20, and the like are allocated to commodity data is set and stored. The discrimination information is described by, for example, an assistance flag G. The assistance flag G is set to, for example, “0” or “1”. If the assistance flag G is “0”, this indicates that assistance message data is not allocated to commodity data. If the assistance flag G is “1”, this indicates that assistance message data is allocated to commodity data. In the assistance message data space 17b-3, specific contents of the assistance message data are set and stored.

In the flash memory 14, a message management program is stored. The message management program causes the CPU 11 to realize an extraction function for extracting message data not allocated to commodity data among data concerning commodities, for example, the additive file 17a or the assistance message file 17b from the memory card 15, a display function for causing the liquid crystal display 4a to display message data of the additive file 17a or the assistance message file 17b, and a deletion function for deleting, from the memory card 15, data instructed to be deleted among the message data of the additive file 17a or the assistance message file 17b displayed on the liquid crystal display 4a.

FIG. 7 is a block diagram of functions realized by the CPU 11 of the apparatus. An extracting unit 11-1 extracts, from the additive file 17a, unused additive data not allocated to commodity data (hereinafter abbreviated as unused additive data) from, for example, the additive file 17a stored in the memory card 15. The extracting unit 11-1 extracts, from the assistance message file 17b, unused assistance message data not allocated to commodity data (hereinafter abbreviated as unused assistance message data) from, for example, the assistance message file 17b stored in the memory card 15.

A display unit 11-2 displays, on the liquid crystal display 4a, the unused additive data or the unused assistance message data extracted by the extracting unit 11-1.

A deleting unit 11-3 deletes, from the additive file 17a, unused additive data instructed to be deleted among the unused additive data or the unused assistance message data displayed on the liquid crystal display 4a. The deleting unit 11-3 deletes, from the assistance message file 17b, unused assistance message data instructed to be deleted among the unused assistance message data displayed on the liquid crystal display 4a.

The deleting unit 11-3 includes a function for making it possible to delete at least one additive data at a time among the additive data included in the additive file 17a displayed by the liquid crystal display 4a and a function for collectively deleting all the additive data included in the additive file 17a. The deleting unit 11-3 includes a function for making it possible to delete at least one assistance message data at a time among the assistance message data included in the assistance message file 17b displayed by the liquid crystal display 4a and a function for collectively deleting all the assistance message data included in the assistance message file 17b.

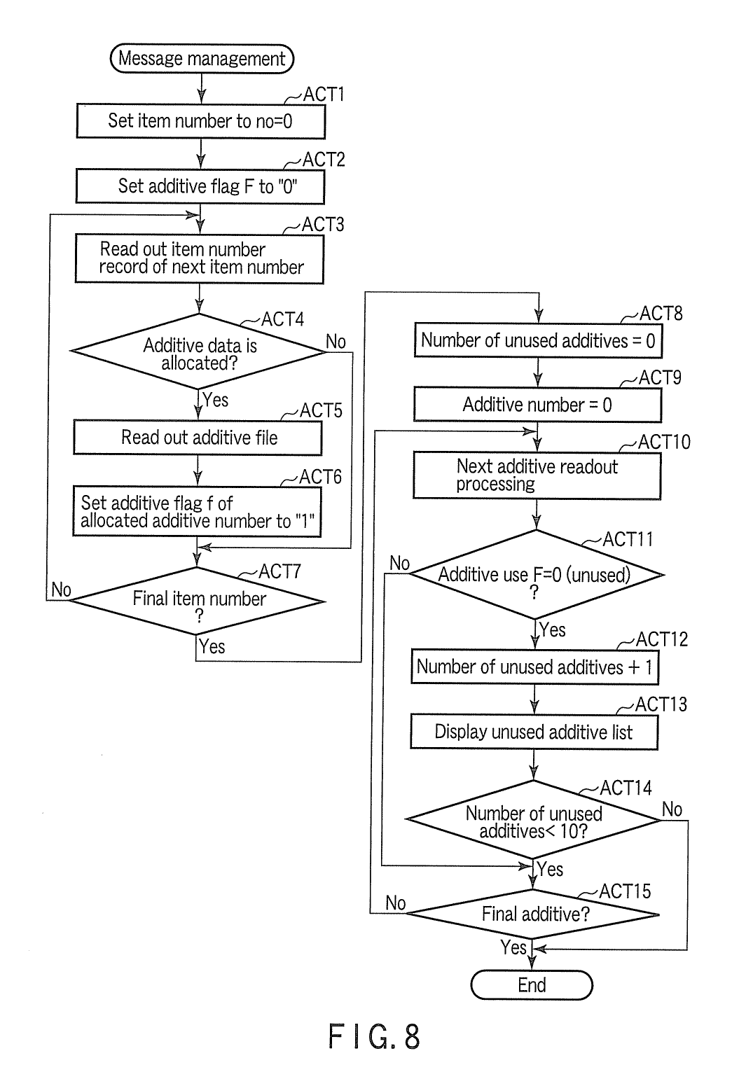

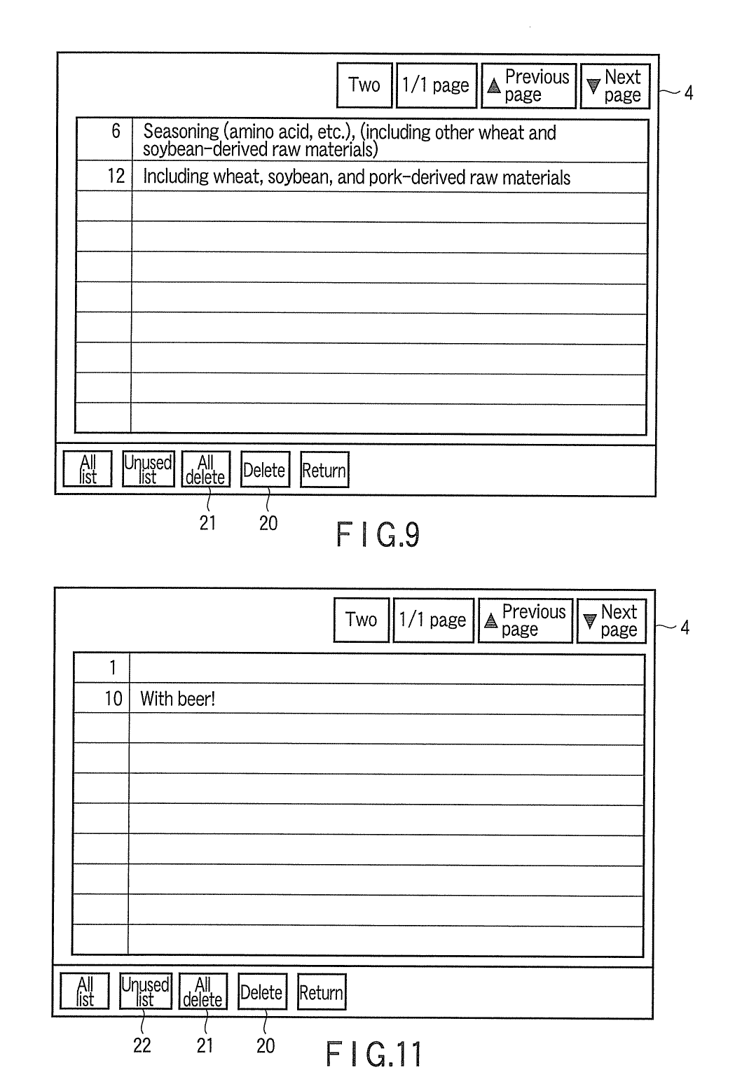

The operation of message management for additives in the printer configured as above is explained below according to a flowchart for explaining message management shown in FIG. 8.

The label printer 1 is set in a setting mode by the operator. In a state in which the label printer 1 is set in the setting mode, the CPU 11 determines whether an instruction for deletion of additive data included in, for example, the additive file 17a shown in FIG. 4 is input by the operator. If the instruction for deletion of the additive data is input, the CPU 11 executes the message management program stored in the flash memory 14.

The extracting unit 11-1 sets an item number (No) of the item number file 16 to “No=0” (ACT 1).

The extracting unit 11-1 sets all the additive flags F in the space 17a-2 for the additive use of the additive file 17a stored in the memory card 15 to “F=0” (ACT 2). All the additive flags F are set to “F=0” in order to acquire, in processing explained below, the latest situation indicating whether additive data is allocated to commodity data of item numbers (No).

The extracting unit 11-1 reads out, from the item number file 16, an item number record of the next item number (No=1) of the item number (No=0) set in ACT 1 and temporarily stores the item number record in the RAM 13 (ACT 3). The extracting unit 11-1 does not always read out the item number record of the item number (No=1) from the item number file 16 and store the item number record in the RAM 13. The extracting unit 11-1 may store item number records of all item numbers (No=1 to m) of the item number file 16 in the RAM 13 and read out the item number record of the item number (No=1) on the RAM 13.

The extracting unit 11-1 determines, from the item number record of the item number (No=1), whether additive data is allocated to commodity data of the item number (No=1) (ACT 4). Specifically, the extracting unit 11-1 reads an additive number set and stored in the additive number space 16-5 in the item number record of the item number (No=1). If the additive number is set and stored, the extracting unit 11-1 determines that additive data is allocated to the commodity data of the item number (No=1). For example, in the additive number space 16-5 of the item number (No=1), an additive number “5” is set and stored as shown in FIG. 3. Therefore, the extracting unit 11-1 determines that additive data is allocated to the commodity data of the item number (No=1).

The extracting unit 11-1 reads out the additive file 17a stored in the memory card 15 and temporarily stores the additive file 17a in the RAM 13 (ACT 5).

Since the additive number “5” is set and stored in the additive number space 16-5 of the item number (No=1) as shown in FIG. 3, the extracting unit 11-1 sets the additive flag F corresponding to the additive number “5” in the additive file 17a shown in FIG. 5 to “F−1” (ACT 6).

The extracting unit 11-1 determines whether the item number (No=1) is a final item number (No=m) (ACT 7). Since the item number (No=1) is not the final item number (No=m), the extracting unit 11-1 returns to ACT 3.

The extracting unit 11-1 reads out an item number record of the next item number (No=2) from the additive file 17a (ACT 3) and determines whether additive data is allocated to commodity data of the item number (No=2) (ACT 4). As shown in FIG. 3, an additive number “2” is set and stored in the additive number space 16-5 of the item number (No=2). Therefore, the extracting unit 11-1 determines that additive data is allocated to the commodity data of the item number (No=2). The extracting unit 11-1 reads out the additive file 17a stored in the memory card 15 (ACT 5) and sets the additive flag F corresponding to the additive number “2” in the additive file 17a to “F=1” (ACT 6).

The extracting unit 11-1 returns to ACT 3 again, reads out an item number record of the next item number (No=3) from the additive file 17a (ACT 3), and determines whether additive data is allocated to commodity data of the item number (No=3) (ACT 4). As shown in FIG. 3, an additive number “0” is set and stored in the additive number space 16-5 of the item number (No=3). Therefore, the extracting unit 11-1 determines that additive data is not allocated to the commodity data of the item number (No=3).

Since the item number (No=3) is not the final item number (No=m), the extracting unit 11-1 returns to ACT 3 again.

Thereafter, in the same manner, the extracting unit 11-1 repeats ACT 3 to ACT 7. If additive data is allocated to commodity data of item numbers, the extracting unit 11-1 repeatedly sets the additive flag F corresponding to relevant additive numbers in the additive file 17a to “F=1”.

As a result, the additive flag F (F=0 or 1) of the latest situation is set in the additive use space 17a-2 in the additive file 17a. In the additive file 17a shown in FIG. 5, for example, the additive flags F of additive numbers “6” and “12” are F=0. Additive data of the additive numbers “6” and “12” are not allocated to commodity data.

When the item number No reaches the final item number (No=m), the extracting unit 11-1 shifts to ACT 8. The extracting unit 11-1 sets the number of unused additive data not allocated to commodities to “0” (ACT 8).

The extracting unit 11-1 sets the additive number No of the additive file 17a shown in FIG. 5 to “0” (ACT 9).

The extracting unit 11-1 reads out additive data of the next additive number (No=1) of the additive number (No=0) from the additive file 17a (ACT 10).

The extracting unit 11-1 determines whether the flag F of the additive data of the additive number (No=1) is “0”, i.e., whether the additive data of the additive number (No=1) is allocated to commodities (ACT 11). Since the flag F of the additive data of the additive number (No=1) is “1”, the extracting unit 11-1 determines that the additive data of the additive number (No=1) is allocated to commodities and shifts to ACT 15.

The extracting unit 11-1 determines whether the additive number (No=1) is a final additive number, for example, an additive number (No=20) (ACT 15). Since the additive number (No=1) is not the final additive number (No=20), the extracting unit 11-1 returns to ACT 10.

The extracting unit 11-1 reads out the flag F (=1) of the next additive number (No=2) (ACT 10) and determines whether the flag F is “0” (ACT 11). Since the flag F of the additive number (No=2) is “1”, the extracting unit 11-1 determines that additive data of the additive number (No=1) is allocated to commodities and shifts to ACT 15. Since the additive number (No=2) is not the final additive number (No=20), the extracting unit 11-1 returns to ACT 10 again.

Thereafter, in the same manner, the extracting unit 11-1 reads out the flags F of the additive data in the order of additive numbers (No=3, 4, and 5) and repeats the determination concerning whether the flags F are “0” (ACTS 10, 11, and 15).

When the additive number No reaches an additive number (No=6), the extracting unit 11-1 reads out additive data of the additive number (No=6) from the additive file 17a (ACT 10). Since the flag F of the additive number (No=6) is “0”, the extracting unit 11-1 determines that the additive data of the additive number (No=6) is not allocated to commodities (ACT 11).

The extracting unit 11-1 adds “1” to the number of unused additive data not allocated to commodities (ACT 12). Since the number of unused additive data not allocated to commodities is set to “0” in ACT 8, the number is increased to “1” by the addition of “1”.

Since the additive data of the additive number (No=6) is determined as not being allocated to commodities, the display unit 11-2 reads out content “seasoning (amino acid, etc.), (including other wheat and soybean-derived raw materials)” of the additive number (No=6) and displays the content “seasoning (amino acid, etc.), (including other wheat and soybean-derived raw materials)” on the liquid crystal display 4a together with the additive number (No=6) (ACT 13).

The extracting unit 11-1 determines whether the number of additive data not allocated to commodities is equal to or smaller than the number set in advance, for example, ten (ACT 14). The set number of additive data is the number enough for realizing a reduction in capacities in use of the memory card 15 and the RAM 13. The set number of additive data is not limited to the number equal to or smaller than 10 and may be set to the number corresponding to the additive number (No=20), for example, the number equal to or smaller than 20.

If the number of additive data not allocated to commodities is smaller than the number set in advance, the extracting unit 11-1 determines whether the additive number (No=6) is the final additive number (No=20) (ACT 15). Since the additive number (No=6) is not the final additive number (No=20), the extracting unit 11-1 returns to ACT 10 again.

The extracting unit 11-1 reads out the flags F of additive data in the order of additive numbers (No=7, 8, . . . , and 11) and repeats determination concerning whether the flags F are “0”) (ACTS 10, 11, and 15). In the additive file 17a shown in FIG. 5, the flags F of the additive data of the additive numbers (No=7, 8, . . . , and 11) are “1”. Therefore, the extracting unit 11-1 determines that the additive data of the additive numbers (No=7, 8, . . . , and 11) are allocated to commodities.

When the additive number No reaches an additive number (No=12), the extracting unit 11-1 reads out the flag F (=0) of the additive number (No=12) in the additive file 17a (ACT 10).

Since the flag F of the additive number (No=12) is “0”, the extracting unit 11-1 determines that additive data of the additive number (No=12) is not allocated to commodities. The extracting unit 11-1 adds “1” to the number of additive data not allocated to commodities and increases the number to “2” (ACT 12).

The display unit 11-2 displays content “including wheat, soybean, pork-derived materials” of the additive number (No=12) on the display 4 together with the additive number (ACT 13).

The extracting unit 11-1 determines again whether the number “2” of additive data not allocated to commodities is equal to or smaller than the number “10” set in advance (ACT 14). The number “2” of additive data not allocated to commodities is smaller than the number “10” set in advance. The extracting unit 11-1 shifts to ACT 15 and determines whether the additive number (No=12) is the final additive number (No=20). Since the additive number (No=12) is not the final additive number (No=20), the extracting unit 11-1 returns to ACT 10 again.

Thereafter, in the same manner, the extracting unit 11-1 reads out the flags F of additive data in the order of additive numbers (No=13, 14, . . . , and 20) and repeats the determination concerning whether the flags F are “0” (ACTS 10, 11, and 15). The flags F of the additive numbers (No=13, 14, . . . , and 20) are “1”. Additive data of the additive numbers (No=13, 14, . . . , and 20) are allocated to commodities.

As a result, as shown in FIG. 9, the display unit 11-2 displays, for example, the additive number “6”, the content “seasoning (amino acid, etc.), (including other wheat and soybean-derived raw materials)” of the additive data of the additive number 6, the additive number “12”, and the content “including wheat, soybean, and pork-derived raw materials” of the additive data of the additive number “12” on the liquid crystal display 4a.

The operator selects, on the display screen of the liquid crystal display 4a, additive data that the operator desires to delete, for example, the additive data of the additive number “6”. For the selection of the additive data of the additive number “6”, the operator touches a position on the display screen of the liquid crystal display 4a corresponding to the additive data of the additive number “6”. The deleting unit 11-3 recognizes, from the touched position on the display screen of the liquid crystal display 4a, the selected additive data of the additive number “6”.

A delete button 20 is displayed on the display screen of the liquid crystal display 4a. The deleting unit 11-3 determines whether the operator touches the delete button 20.

If the operator touches the delete button 20, the deleting unit 11-3 deletes, on the RAM 13, the additive data of the additive number “6” from the additive file 17a. If the operator touches an all-delete button 21, the deleting unit 11-3 collectively deletes all the additive data of the additive numbers “6” and “12” from the additive file 17a on the RAM 13.

After the additive data not allocated to commodities is deleted, the CPU 11 overwrites the memory card 15 with the additive file 17a stored in the RAM 13. The additive file 17a from which the additive data not allocated to commodities is deleted is stored in the memory card 15.

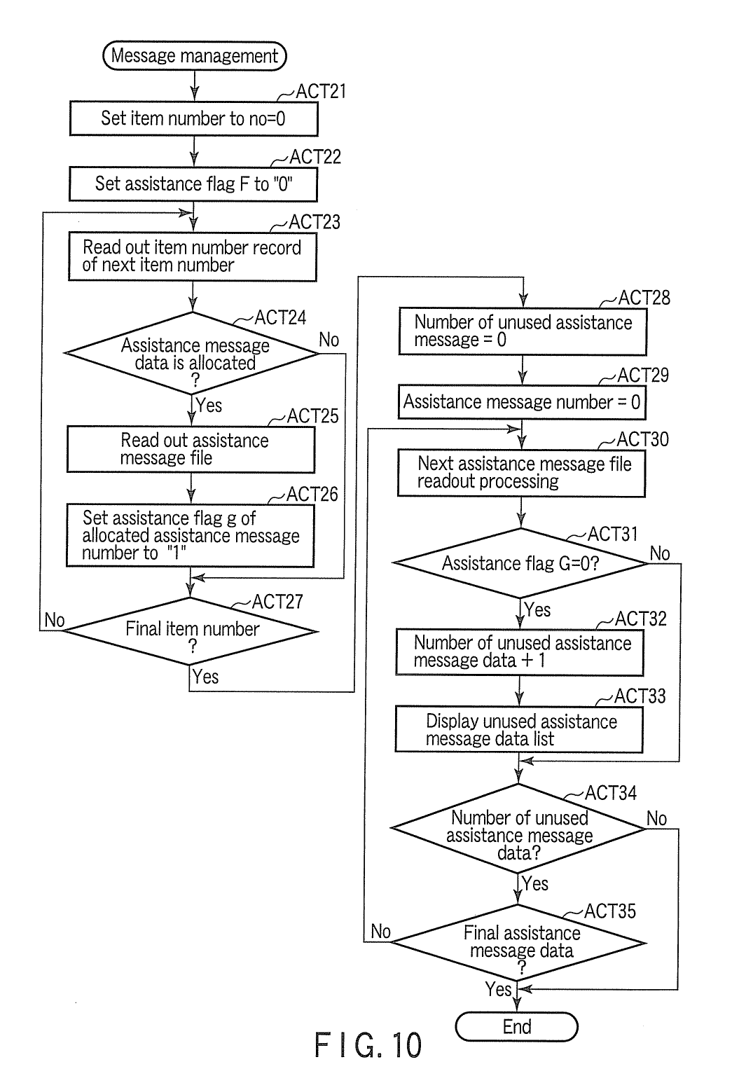

The operation of message management for the assistance message file 17b not allocated to commodities is explained below according to a flowchart for explaining the message management shown in FIG. 10.

In a state in which the label printer 1 is set in the setting mode, the CPU 11 determines whether an instruction for deletion of assistance message data included in, for example, the assistance message file 17b shown in FIG. 6 is input by the operator. If the instruction for deletion of assistance message data is input, the CPU 11 executes the message management program stored in the flash memory 14.

The extracting unit 11-1 sets the item number (No) of the item number file 16 to “No=0” (ACT 21) and sets all the assistance flags G of the assistance message allocation space 17b-2 of the assistance message file 17b stored in the memory card 15 to “G=0” (ACT 22). All the assistance flags G are set to “G=0” in order to acquire, in processing explained below, the latest situation indicating whether assistance message data is allocated to commodity data of item numbers (No).

The extracting unit 11-1 reads out, from the item number file 16, an item number record of the next item number (No=1) of the item number (No=0) set in Act 21 and temporarily stores the item number record in the RAM 13 (ACT 23).

The extracting unit 11-1 determines, from the item number record of the item number (No=1), whether assistance message data is allocated to commodity data of the item number (No=1) (ACT 24). Specifically, as shown in FIG. 3, an additive number “3” is set and stored in the assistance message number space 16-6 of the item number (No=1). Therefore, the extracting unit 11-1 determines that assistance message data is allocated to the commodity data of the item number (No=1).

The extracting unit 11-1 reads out the assistance message file 17b stored in the memory card 15 and temporarily stores the assistance message file 17b in the RAM 13 (ACT 25).

The extracting unit 11-1 sets the assistance flag G corresponding to the assistance message number “3” in the assistance message file 17b to “G=1” (ACT 26).

The extracting unit 11-1 determines whether the item number (No=1) is a final item number (No=m) (ACT 27). Since the item number (No=1) is not the final item number (No=m), the extracting unit 11-1 returns to ACT 23.

Thereafter, in the same manner, the extracting unit 11-1 repeats ACT 22 to ACT 27. If assistance message data is allocated to commodity data, the extracting unit 11-1 repeatedly sets the assistance flag G corresponding to an assistance message number in the assistance message file 17b to “G=1”.

As a result, the assistance flag G (G=0 or 1) of the latest situation is set in the assistance message allocation space 17b-2 in the assistance message file 17b. In the assistance message file 17b shown in FIG. 6, for example, the assistance flag G of an assistance message number “10” is G=0. Assistance message data of the assistance message number “10” is not allocated to commodity data.

When the item number No reaches the final item number (No=m), the extracting unit 11-1 shifts to ACT 8. The extracting unit 11-1 sets the number of unused assistance message data not allocated to commodities to “0” (ACT 28).

The extracting unit 11-1 sets an assistance message number No of the assistance message file 17b shown in FIG. 6 to “0” (ACT 29).

The extracting unit 11-1 reads out assistance message data of the next assistance message number (No=1) from the assistance message file 17b (ACT 30).

The extracting unit 11-1 determines whether the assistance flag G of the assistance message number (No=1) is “0”, i.e., whether the assistance message data of the assistance message number (No=1) is allocated to commodities (ACT 31). Since the assistance flag G of the assistance message number (No=1) is “0”, the extracting unit 11-1 determines that the assistance message data of the assistance message number (No=1) is not allocated to commodities.

The extracting unit 11-1 adds “1” to the number of unused assistance message data not allocated to commodities (ACT 32). Since the number of unused assistance message data not allocated to commodities is set to “0” in ACT 28, the number is increased to “1” by the addition of “1”.

Since the assistance message data of the assistance message number (No=1) is determined as not being allocated to commodities, the display unit 11-2 displays assistance message data set and stored in the assistance message data space 17b-3 corresponding to the assistance message number (No=1) on the liquid crystal display 4a (ACT 33). Assistance message data is not set and stored in the assistance message data space 17b-3 of the assistance message number (No=1). Therefore, assistance message data is not displayed on the liquid crystal display 4a.

The extracting unit 11-1 determines whether the number of assistance message data not allocated to commodities is equal to or smaller than the number set in advance (ACT 34). The set number of assistance message data is the number enough for realizing a reduction in capacities in use of the memory card 15 and the RAM 13.

If the number of assistance message data not allocated to commodities is equal to or smaller than the number set in advance, the extracting unit 11-1 determines whether the assistance message number (No=1) is a final assistance message number, for example, an assistance message number (No=10) (ACT 35). Since the assistance message number (No=1) is not the final assistance message number (No=10), the extracting unit 11-1 returns to ACT 30.

The extracting unit 11-1 reads out the assistance flags G (=1) of the next assistance message number (No=2) (ACT 30) and determines whether the assistance flag G is “0” (ACT 31). Since the assistance flag G of the assistance message number (No=2) is “1”, the extracting unit 11-1 determines that the assistance message data of the assistance message number (No=1) is allocated to commodities and shifts to ACT 35. Since the assistance message number (No=2) is not the final assistance message number (No=10), the extracting unit 11-1 returns to ACT 30 again.

In the same manner as the above, the extracting unit 11-1 reads out the assistance flags G of assistance message data in the order of assistance message numbers (No=3, 4, . . . , and 9) and repeats the determination concerning whether the assistance flags G are “0” (ACTS 30, 31, and 35).

When the assistance message number No reaches the assistance message number (No=10), the extracting unit 11-1 reads out assistance message data of the assistance message number (No=10) from the assistance message file 17b (ACT 30).

The extracting unit 11-1 determines whether the assistance flag G of the assistance message number (No=10) is “0” (ACT 31). In the assistance message file 17b shown in FIG. 6, the assistance flag G of the assistance message number (No=10) is “0”. Therefore, the extracting unit 11-1 determines that the assistance message data of the assistance message number (No=10) is not allocated to commodities.

The extracting unit 11-1 adds “1” to the number of unused assistance message data not allocated to commodities and increases the number to “2” (ACT 32).

The display unit 11-2 displays assistance message data set and stored in the assistance message data space 17b-3 corresponding to the assistance message number (No=10), for example, a message “with beer” in the assistance message file 17b shown in FIG. 6 on the liquid crystal display 4a together with the assistance message number (No=10) (ACT 33).

The extracting unit 11-1 determines whether the number of assistance message data not allocated to commodities is equal to or smaller than the number set in advance (ACT 34). If the number of assistance message data not allocated to commodities is equal to or smaller than the number set in advance, the extracting unit 11-1 shifts to ACT 35.

As a result, as shown in FIG. 11, the display unit 11-2 displays, for example, the assistance message number “1”, content “no setting” of assistance message data of the assistance message number “1”, the assistance message number “10”, and content “with beer” of assistance message data of the assistance message number “10” on the liquid crystal display 4a.

The operator touches a position on the display screen of the liquid crystal display 4a and selects assistance message data that the operator desires to delete, for example, the assistance message data of the assistance message number “10”. The deleting unit 11-3 recognizes, from the touched position on the display screen of the liquid crystal display 4a, the selected assistance message data of the assistance message number “10”.

The deleting unit 11-3 determines whether the operator touches the delete button 20. If the operator touches the delete button 20, the deleting unit 11-3 deletes the assistance message data of the assistance message number “10” from the assistance message file 17b. If the operator touches the all-delete button 21, the deleting unit 11-3 collectively deletes, in the display example shown in FIG. 9, all the assistance message data of the assistance message numbers “1” and “10” from the assistance message file 17b.

After the assistance message data not allocated to commodities is deleted, the CPU 11 overwrites the memory card 15 with the assistance message file 17b stored in the RAM 13. The assistance message file 17b in which the assistance message data not allocated to commodities is deleted is stored in the memory card 15.

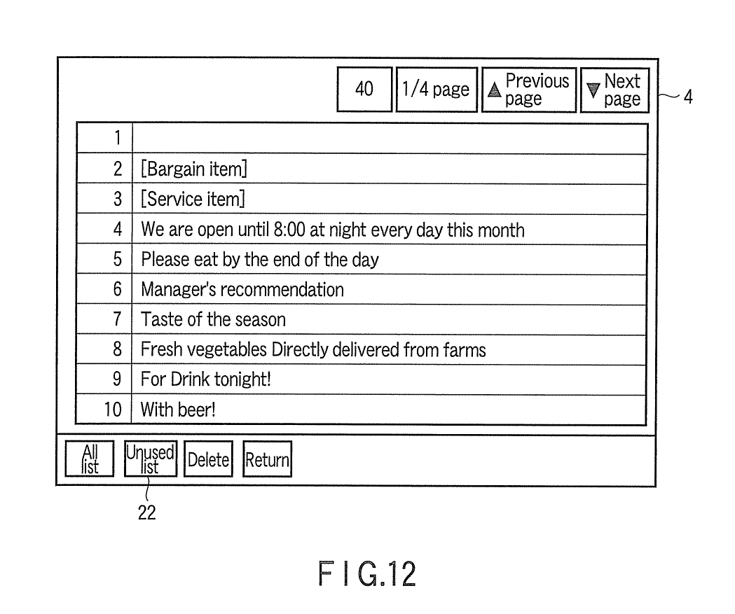

The display unit 11-2 may display, as shown in FIG. 12, all the assistance message data set and stored in the assistance message file 17b on the liquid crystal display 4a. In this case, an unused list button 22 is displayed on the display screen of the liquid crystal display 4a. The unused list button 22 is a button for selecting, from all the assistance message data, unused message data not allocated to commodities.

When the operator touches the unused list button 22, in the same manner as the above, as shown in FIG. 12, the display unit 11-2 displays, on the liquid crystal display 4a, the unused assistance message data not allocated to commodities, for example, the assistance message number “1”, content “blank (meaning that no setting is made)” of the assistance message data of the assistance message number “1”, the assistance message number “10”, and content “with beer” of the assistance message data of the assistance message number “10”.

The operator touches a position on the display screen of the liquid crystal display 4a and selects assistance message data that the operator desires to delete, for example, the assistance message data of the assistance message number “10”. The deleting unit 11-3 recognizes, from the touched position on the display screen of the liquid crystal display 4a, the selected assistance message data of the assistance message number “10”.

The deleting unit 11-3 determines whether the operator touches the delete button 20. If the operator touches the delete button 20, the deleting unit 11-3 deletes the assistance message data of the assistance message number “10” from the assistance message file 17b.

As explained above, according to the embodiment, it is possible to extract the additional message data 17, for example, additive data of the additive file 17a or assistance message data of the assistance message file 17b not allocated to commodity data, check the additive data or the assistance message data not allocated to commodities, and delete the additive data or the assistance message data instructed to be deleted. As the data to be deleted, one or both of the additive data and the assistance message data can be selected. It is possible to realize a reduction in capacities in use of the memory card 15 and the RAM 13 by deleting the additive data or the assistance message data.

In particular, the additive data stored in the additive file 17a are often respectively allocated to plural commodities. It is possible to check and delete additive data not allocated to commodities among a large number of additive data.

Since the additive data is allocated to a large number of commodities such as foods, the additive data occupies a large percentage of memory areas of the memory card 15 and the RAM 13. Therefore, the additive data weights heavily on usable memory areas in the memory card 15 and the RAM 13. It is possible to increase usable memory capacities in the memory card 15 and the RAM 13 by deleting the additive file 17a not allocated to commodities.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the explanation of the embodiment, the additive file 17a and the assistance message file 17b are extracted from the memory card 15 as additional message data, displayed, and deleted. However, the embodiments are not limited to this. The additional message data also includes, for example, places of origin data, data of storage temperatures, data of storage methods, data of commercial messages of commodities, and data concerning recipes in cooking commodities, nutrients and calories of commodities such as foods, and amino acid as a component of protein. In the embodiments, it is also possible to extract the data from the memory card 15 and display the data on the liquid crystal display 4a and delete data instructed to be deleted among these additional message data.

What is claimed is:

1. A printer comprising:
a commodity file configured to store, by commodity, commodity data including at least names of commodities;
a message file configured to store massage data allocated to the commodity data and combined with the commodity data;
a printing unit configured to print, in addition to the commodity data, the message data allocated to the commodity data on a label;
an extracting unit configured to extract, from the message file, the message data allocated to none of the commodity data;
a display unit configured to display the message data extracted by the extracting unit; and
a deleting unit configured to delete, from the message file, the message data displayed by the display unit.

2. The printer according to claim 1, wherein, when a plurality of the message data allocated to none of the commodity data are displayed on the display unit, the deleting unit selectively deletes at least one of the message data displayed on the display unit.

3. The printer according to claim 1, wherein, when a plurality of the message data allocated to none of the commodity data are displayed on the display unit, the deleting unit collectively deletes all the message data displayed on the display unit.

4. The printer according to claim 1, wherein the message file includes an additive file having, as message data, information concerning additives contained in the commodities and an assistance message file having, as message data, assistance message data for assisting sales promotion of the commodities.

5. The printer according to claim 4, wherein
the additive file includes first discrimination information representing whether additive data as the message data is allocated to at least any one of the commodity data,
the extracting unit extracts, on the basis of the first discrimination information, the additive data allocated to none of the commodity data from the additive file,
the display unit displays the additive data extracted by the extracting unit; and
the deleting unit deletes the additive data displayed by the display unit.

6. The printer according to claim 4, wherein
the assistance message file includes second discrimination information representing whether assistance message data as the message data is allocated to at least any one of the commodity data,
the extracting unit extracts, on the basis of the second discrimination information, the assistance message data allocated to none of the commodity data from the assistance message file,
the display unit displays the assistance message data extracted by the extracting unit; and
the deleting unit deletes the assistance message data displayed by the display unit.

7. A printer comprising:
a first storing unit configured to store, by commodity, commodity data including at least names of commodities;
a second storing unit configured to store plural message records including message data allocated to the commodity data and discrimination information representing whether the message data is allocated to at least any one of the commodity data;
an extracting unit configured to extract, on the basis of the discrimination information, the message data allocated to none of the commodity data;
a display unit configured to display the message data extracted by the extracting unit; and
a deleting unit configured to delete, from the second storing unit, the message data displayed by the display unit.

8. The printer according to claim 7, wherein
the second storing unit stores an additive file having information concerning whether additives are contained in the commodities,
the extracting unit extracts, on the basis of the discrimination information, the additive data allocated to none of the commodity data from the additive file,
the display unit displays the additive data extracted by the extracting unit; and
the deleting unit deletes the additive data displayed by the display unit.

9. The printer according to claim 7, wherein
the second storing unit stores an assistance message file for assisting sales and promotion of the commodities,
the extracting unit extracts, on the basis of the discrimination information, the assistance message data allocated to none of the commodity data from the assistance message file,
the display unit displays the assistance message data extracted by the extracting unit; and
the deleting unit deletes the assistance message data displayed by the display unit.

10. A method of managing plural message data printed by a printer including: a commodity file configured to store, by commodity, commodity data including at least names of commodities; a message file configured to store massage data allocated to the commodity data and combined with the commodity data; and a display unit configured to display at least the message data, the method comprising:
extracting, from the message file, the message data allocated to none of the commodity data;
displaying the extracted message data on the display unit;
receiving an instruction for deleting the message data displayed on the display unit; and
deleting the message data, the instruction for deletion of which is received, from the message file.

11. The method according to claim 10, wherein, when a plurality of the message data allocated to none of the commodity data are extracted by the extraction of the message data, in the deletion of the message data, at least one of the displayed message data is selectively deleted.

12. The method according to claim 10, wherein, when a plurality of the message data allocated to none of the commodity data are extracted by the extraction of the message data, in the deletion of the message data, all the message data displayed on the display unit are collectively deleted.

13. The method according to claim 10, wherein
the message file includes discrimination information representing whether the message data is allocated to at least one of the commodity data in the commodity file, and
in the extraction of the message data, message data allocated to none of the commodity data in the commodity file is extracted from the file on the basis of the discrimination information in the message file.
